(19) United States
(12) Patent Application Publication
(10) Pub. No.: US 2026/0237944 A1
(43) Pub. Date: Aug. 13, 2026

(54) CABLE GLAND WITH A SHIELD CONTACT MODULE

(71) Applicant: Lapp Engineering AG, Cham (CH)

(72) Inventor: Daniel MÜLLER, Remseck am Neckar (DE)

(73) Assignee: Lapp Engineering AG, Cham (CH)

(21) Appl. No.: 19/530,804

(22) Filed: Feb. 5, 2026

(30) Foreign Application Priority Data
Feb. 12, 2025 (EP) 25157519.7

(51) Int. Cl. H01R 13/6592; H01R 13/24; H01R 13/422; H01R 13/6582; H02G 3/22

(52) U.S. Cl. CPC H01R 13/6592; H01R 13/2442; H01R 13/2464; H01R 13/422; H01R 13/6582; H02G 3/22

(57) ABSTRACT

A cable gland, includes: one or multi-piece mounting socket including socket channel for cable to pass through, first and second connecting pieces with first and second external threads, that's connectable to mounting wall, cap nut includes cap nut channel for cable to pass through, pressure cap, and ring flange with internal thread corresponding to second external thread of mounting socket, securing device by which the cable can be fixed in tight-fitting manner, and shield contact module, arranged within socket channel, which has annular or hollow cylindrical support member and contact elements connected to support member, which protrude into socket channel and provide contacting cable shield of cable. Contact elements formed as contact tongues, each including tongue neck and tongue head, which tongue head forms tongue tub with tub space that's closed toward central axis and bounded by tub bottom facing central axis and continuous closed tub wall, adjoining tub bottom.

The invention relates to a cable gland that is provided for feeding a cable, which has a cable shield, through a mounting opening in a mounting wall and which comprises a shield contact module by means of which the cable shield of the cable can be contacted.

Cable glands or threaded cable feed-throughs allow cables to be fed through walls and housings of electrical control cabinets, electrical devices, and the like. The purpose of the cable gland is to prevent damage to the cable in the feed-through area and to secure the cable to the mounting wall in a manner that is resistant to tension and pressure. In addition, cable glands ensure that, depending on the requirements of the situation, the cable is routed through the wall in a dust-/gas-/liquid-tight manner. Cable glands with an installed shield contact module also allow contact to be made with a cable shield, thereby reducing or eliminating electromagnetic interference and electromagnetic disturbances. Interference voltages occurring on the cable shield are diverted to the mounting wall via a mounting socket, for example, using the shield contact module.

Various elements for cable glands are known from the prior art, which serve to tightly enclose and/or mechanically fix a cable passing through. Various shield contact modules for cable glands are also known, which serve to contact the cable shield of a cable passing through.

EP2688169A1 discloses a cable gland with a mounting unit that can be connected to a wall element, with a shield contact module, with a fixing housing that is screwable to the mounting unit and that has a lamella basket with lamellas arranged in a circle, with a ring seal that is enclosed by the lamellas, and with a cable fixing unit in the form of a cap nut that is screwable to the fixing housing. The cap nut allows the lamella basket to be acted upon along its longitudinal axis so that the lamellas are pressed against the ring seal, which is pressed against the cable and seals it and fixes it mechanically. The mounting unit is designed so that it creates an electrically conductive connection between the shield contact module and the wall element. The shield contact module has a hollow cylindrical retaining part that surrounds a central axis and from which spring-elastic contact elements extend radially toward the central axis. The contact elements are designed, for example, as contact fingers or contact brackets and are integrally formed onto the retaining part. The contact brackets have a bracket curve at the end facing the central axis, which prevents the contact brackets from catching on the exposed cable shield when the cable is inserted axially into the cable gland. If, on the other hand, the shield braid is loose or the cable is twisted, the contact elements can hook into the braid of the cable shield, causing the contact elements to twist elastically and possibly overstretch. This process can result in damage to the contact elements of the shield contact module and/or to the braid of the cable shield. It is possible that there will remain poor contact between the shield contact module and the cable shield.

EP1022836A2 discloses another cable gland with a mounting unit in the form of a mounting socket onto which a cap nut can be placed and in which a shield contact module, a lamella basket with circularly arranged lamellas, and a ring seal enclosed by the lamellas are arranged. The shield contact module comprises a support member with spring-elastic contact brackets that extend towards the central axis of the shield contact module. The contact brackets have a V-shaped bracket curve that is designed to make contact with the cable shield of an inserted cable. Furthermore, the contact brackets touch the connector in the area of its inner cylindrical surface so that contact can be established between the cable shield and the connector. The V-shaped bracket curve allows axial displacement of the cable without the contact brackets hooking into the braid of the cable shield if it has no weaknesses. However, if the shield braid is loose or the cable is twisted, the contact elements can also become caught in the braid of the cable shield in this cable gland, causing the contact elements to twist elastically and possibly become overstretched.

With cable glands of this type, damage to the cable gland and/or the cable can therefore occur after just one or several uses, especially if the cable is twisted or the cable shield braiding is not in optimal condition.

If a foil is used as a cable shield instead of a braid, the contact elements can cause abrasion marks on the foil when the cable is moved or rotated, which may tear it open.

Another disadvantage is that the cable glands commonly available often provide insufficient electrical contact between the contact elements and the cable shield of the installed cable, resulting in contact resistance. The contact elements often only make contact with the cable shield at specific points.

EP3832806B1 discloses a plug connector with a shielding sleeve having a cylindrical sleeve region for contacting a cable shielding and a spring region with a multiplicity triangular spring elements that are provided with a convexity that is in contact with the metallic housing of the plug connector. The convexity results in a reduced contact area with a point contact surface that greatly increases the surface pressure and supports particularly reliable contacting. EP3832806B1 therefore recommends contacting cable shielding with a cylindrical sleeve region.

The invention is therefore based on the objective of creating an improved cable gland with a shield contact module and an improved shield contact module.

In particular, a cable gland shall be created that functions optimally even after repeated use and that ensures perfect contact with the cable shield of an installed cable.

The cable gland shall be designed in such a way that damage to the shield contact module and the associated contact elements as well as the cable shield, a shield braid or a foil, is avoided. Damage to the shield contact module and the associated contact elements as well as the cable shield shall be avoided even in the event of unfavorable insertion and multiple twists of the cable as well as in the event of the cable shield being in poor condition.

The cable gland is designed to ensure good contact with the cable shield, for example a metal foil or metal braid, regardless of the diameter of the installed cable.

The inventive shield contact module, which is used to solve the above-mentioned tasks, shall be advantageously applicable in any cable glands and shall be adaptable to any cable gland with little effort.

These tasks are solved with a cable gland according to claim 1 and a shield contact module according to claim 15. Advantageous embodiments of the invention are specified in further claims.

The cable gland (1), which has a central axis (x) and is designed for feeding a cable (8), which is provided with a cable shield (82), through a mounting opening (90) in a mounting wall (9), in particular a housing wall of an electrical device or an electrical cabinet, comprises
a one-piece or multi-piece mounting socket which has a socket channel for the cable to pass through, a first connecting piece provided with a first external thread, and a second connecting piece provided with a second external thread, and which is connectable to the mounting wall,
a cap nut that has a cap nut channel for the cable to pass through, a pressure cap, and a ring flange with an internal thread that corresponds to the second external thread of the mounting socket,
a securing device by means of which the cable can be fixed in a tight-fitting manner, and
with a shield contact module, which is arranged within the socket channel, which has an annular or hollow cylindrical support member and several contact elements connected to the support member, which protrude into the socket channel and are provided for contacting the cable shield of the cable.

According to the invention, the contact elements are formed as contact tongues, each of which has a tongue neck connected to the support member and a tongue head adjoining the tongue neck, which tongue head forms a tongue tub with a tub space that is closed toward the central axis and is bounded by a tub bottom facing the central axis and a continuous closed tub wall, which is adjoining the tub bottom.

The inventive shield contact module can be used in any cable glands that have a central axis along which a cable equipped with a cable shield can be fed through the cable gland. The hollow cylindrical, ring-shaped or sleeve-shaped support member is adapted to the dimensions of the passage channel of a one-piece or multi-piece mounting socket, which may comprise a mounting unit. Preferably, the support member is compressible so that it can be inserted into the mounting socket with a press fit.

The cable gland may have any fixing device, which may include a lamella basket and/or an elastic sealing ring, which can be pressed directly or indirectly onto an inserted cable by means of the cap nut via the lamellas of the lamella basket in order to fix it in place and seal the passage channel.

By designing the contact elements as contact tongues with a tongue neck and a tongue head adjoining the tongue neck, which tongue head forms a tongue tub with a tub space that is closed toward the central axis and is bounded by a tub bottom facing the central axis and a continuous closed tub wall adjoining the tub bottom, it is ensured that only the side of the tongue head facing the central axis comes into contact with the cable shield.

The tongue neck is elastic, while the tongue head has little or no elasticity. The tongue neck thus ensures that the tongue head can rotate preferably in a plane radial to the central axis depending on the cable diameter when a cable is inserted.

In preferred embodiments, the tongue neck is designed in the form of a swan neck, first extending upward and then along a curve of approximately 180° (+/−30°), and subsequently forming an opening angle a with the wall of the support member, which is preferably in the range of 40° (+/−10 °).

Due to the advantageous design of the contact tongues, a cable can be inserted into the cable gland and moved back and forth axially and rotated within the device channel with the cable shield as desired without the tongue head of one of the contact tongues engaging with the braiding of the cable shield or damaging a cable shield designed as a foil. Even if the tongue head is bent and rotated elastically under force or the cable shield no longer fits tightly against the underlying cable insulation, there is no risk that a tongue head of the contact tongues will engage with the braiding of the cable shield or damage a cable shield designed as a foil. Due to the advantageous design of the tongue head, bending of the contact tongues can be largely avoided.

The tongue heads of the contact tongues, which have a relatively large contact surface, ensure perfect contact with the cable shield of the installed cable, so that interference voltages can be reliably discharged to the mounting wall via the mounting socket.

Each tongue head preferably comprises a tongue dish, which delimits the tub space laterally on the sides, and a tongue front adjoining the tongue dish, which delimits the tub space at the front. The tongue dish and the tongue front form the tub wall, which is continuously closed but preferably decreases in height towards the tongue neck.

The tongue dish is preferably designed in a channel shape. The tongue front adjoining the tongue dish is preferably rounded or designed as a spherical segment, for example as a quarter of a sphere.

This design of the tongue head has several advantages. On the one hand, it results in gentle mechanical contact between the cable shield and the tongue head. On the other hand, it results in particularly good electrical contact between the cable shield and the tongue head.

When inserting the cable with the exposed cable shield into the cable gland, the rounded or spherical tongue front of the tongue head first comes into contact with the cable shield. As a result, the spring-loaded contact tongue is bent back so that the tongue dish can at least partially come into contact with the cable shield.

The tub bottom of the tongue head preferably has a flat or only slightly rounded contact zone on the rear side, which ensures flat contact with the cable shield. However, this tub back may also have an indentation adapted to the circumference of the cable, which improves contact.

In further preferred embodiments, the tub back facing the central axis is preferably provided with indentations or formations through which several contact connections between the cable shield and the tongue head can be realized. The formations, for example cams or combs, can penetrate the braid of the cable shield and create particularly good contacts. In contrast, the braid of the cable shield can be displaced into the indentations in the tongue head, which in turn achieves good contact. It is sufficient if these indentations or formations are only of low height, so that only minimal mechanical interaction results when the cable is inserted or rotated.

Formations and indentations, which are preferably wave-shaped, are preferably arranged in a concave area of the tongue head or tongue bottom, which is designed to accommodate a part of the cable shield.

The length of the tongue head consists of the length of the tongue dish and the length of the tongue front, whereby the length of the tongue dish is approximately 1.5 to 5.0 times greater than the length of the tongue front. The length of the tongue front is selected such that the tongue front can fulfill its function in contacting the cable shield as intended and disruptive interaction between the cable shield and the tongue front is avoided. After mechanical contact of the tongue front when the cable is inserted, the tongue head is rotated by an angle in the range of, for example, 0°-40°. The larger the diameter of the cable, the greater the angle of rotation of the tongue head. As a result, the tongue dish can come into contact with the cable shield over a greater length, resulting in optimal contact with the cable shield.

The support member of the shield contact module is preferably hollow cylindrical in shape and comprises a carrier wall that is in electrical contact with the channel wall of the connector channel. The contact tongues form an opening angle with the support wall that is in the range of 30°-50°, preferably around 40°. The opening angle is selected so that the edges of the tongue front cannot come into contact with the cable shield of an inserted cable and so that the tongue head is always turned against the support wall and not pulled against the central axis when a cable is inserted.

The tongue head has a first radius of curvature in the area adjacent to the tongue carrier and a second radius of curvature in the area of the tongue front. Preferably, the first radius of curvature is higher than the second radius of curvature by a factor in the range of 1.5-3.5. Adjacent to the tongue carrier, the tongue head therefore has a relatively low slope. In contrast, the tongue front is strongly curved.

The support member and the contact tongues, which are preferably connected to the support member in one piece, are preferably cut out and formed from a sheet metal part. In this way, the shield contact module can be manufactured particularly cost-effectively.

In alternative embodiments, the support member and the contact tongues are connected to each other in a form-fitting and/or force-fitting manner, or by means of a welded connection or an adhesive connection. A part of the mounting socket into which the contact tongues are inserted in a form-fitting and/or force-fitting manner can also serve as a support member. The support member can therefore also be integrated into the mounting socket.

The material thickness of the contact tongues is preferably at least approximately constant across the area of the tongue neck and tongue head. The tongue head is stiffened by its formation.

The contact tongues are preferably inclined in a direction away from the cap nut. In a further preferred embodiment, the support member may also be provided with contact tongues at both ends, which are directed towards each other and inclined towards the central axis.

The invention is explained in more detail below with reference to drawings. These show:

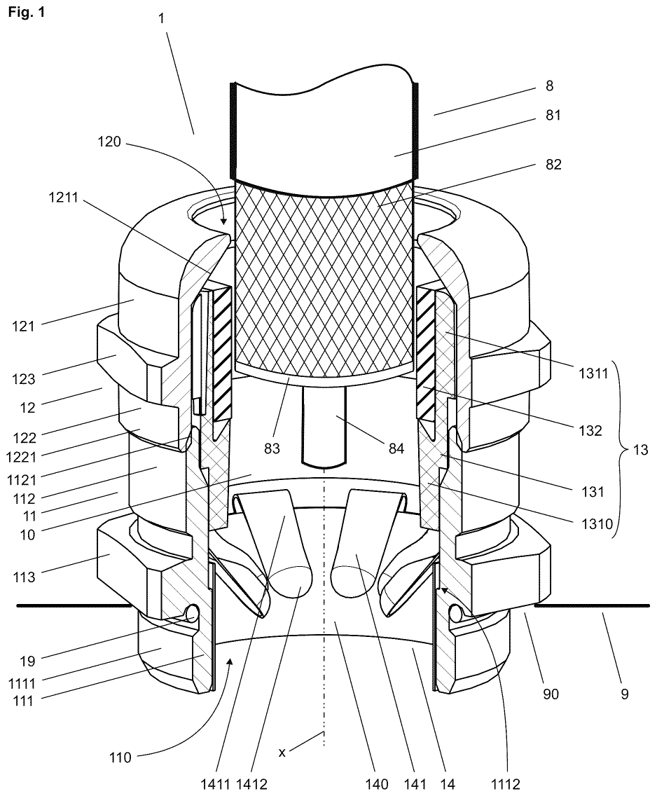

FIG. 1 an inventive cable gland 1 connected to a mounting wall 9, with a mounting socket 11, with a cap nut 12 screwed to the mounting socket 11, with a securing device 13 and with a shield contact module 14, which is arranged inside the mounting socket 12 and has radially opposed contact tongues 141, which are connected to a hollow cylindrical support member 140 and which are designed to contact the exposed cable shield 14 of a cable 8 that is fed through the cable gland 1 and the mounting wall 9 along a central axis x;

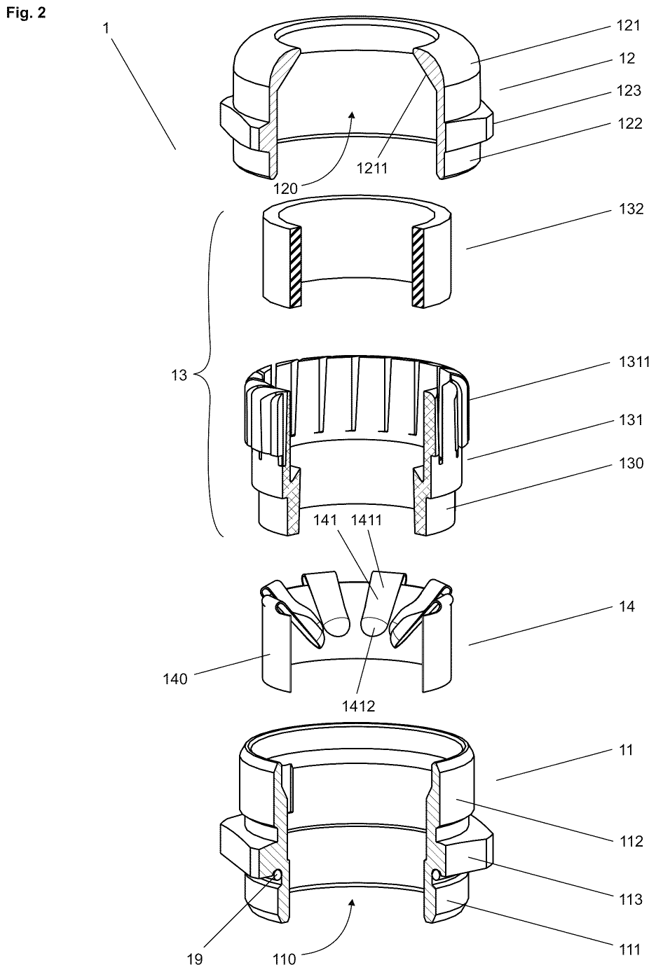

FIG. 2 the cable gland 1 of FIG. 1 in exploded view;

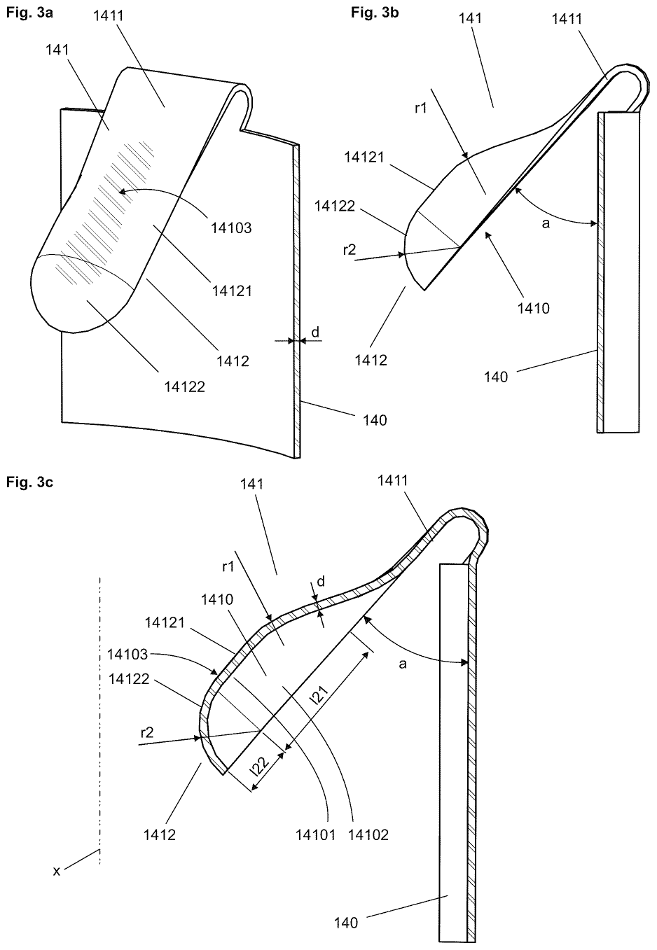

FIG. 3a one of the contact tongues 141 of the shield contact module 14 of FIG. 1;

FIG. 3b the contact tongue 141 of FIG. 3a from the side;

FIG. 3c the contact tongue 141 of FIG. 3b in sectional view;

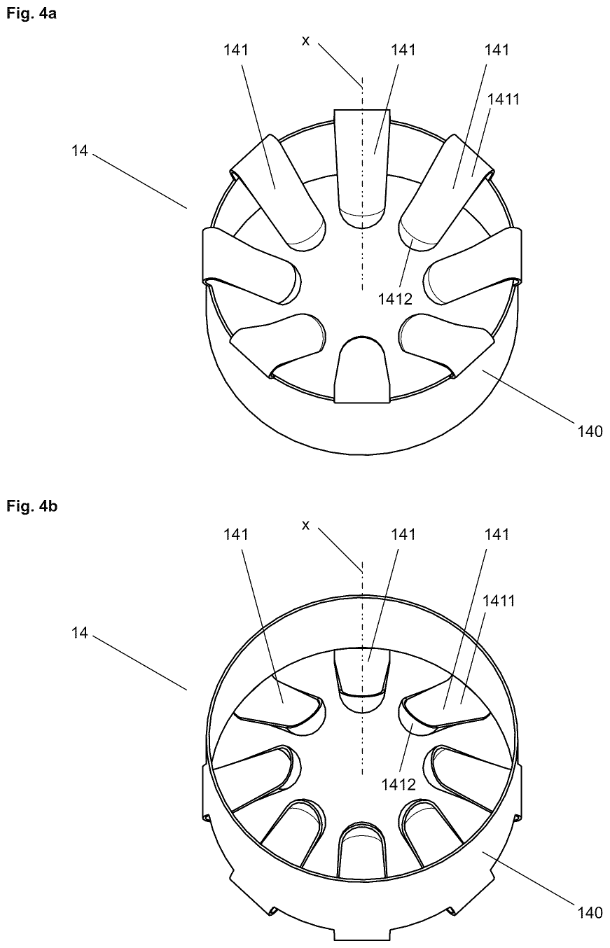

FIG. 4a the upper side of the shield contact module 14 of FIG. 1 with eight contact tongues 141, which have a tongue neck 1411 and, adjoining thereto, a curved tongue head 1412;

FIG. 4b the lower side of shield contact module 14 of FIG. 3a;

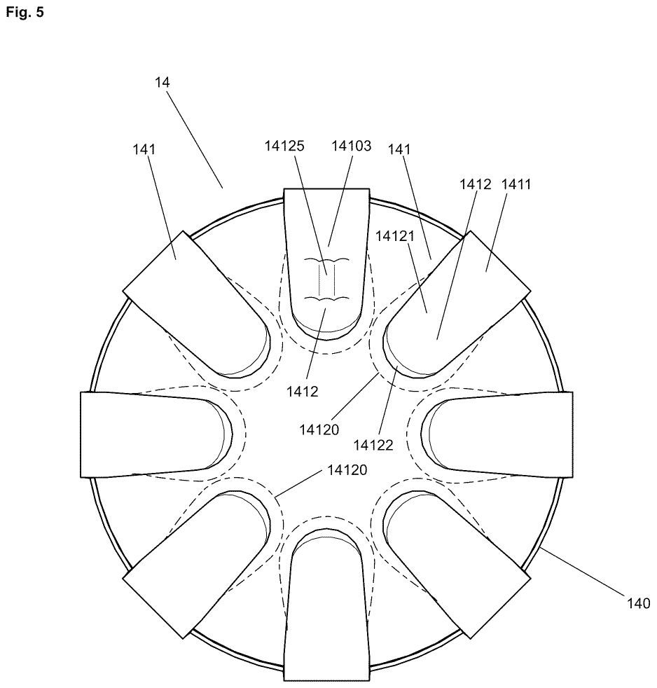

FIG. 5 the shield contact module 14 of FIG. 4a with an exemplary unfolding 14120 of the tongue head 1412 of the contact tongues 141;

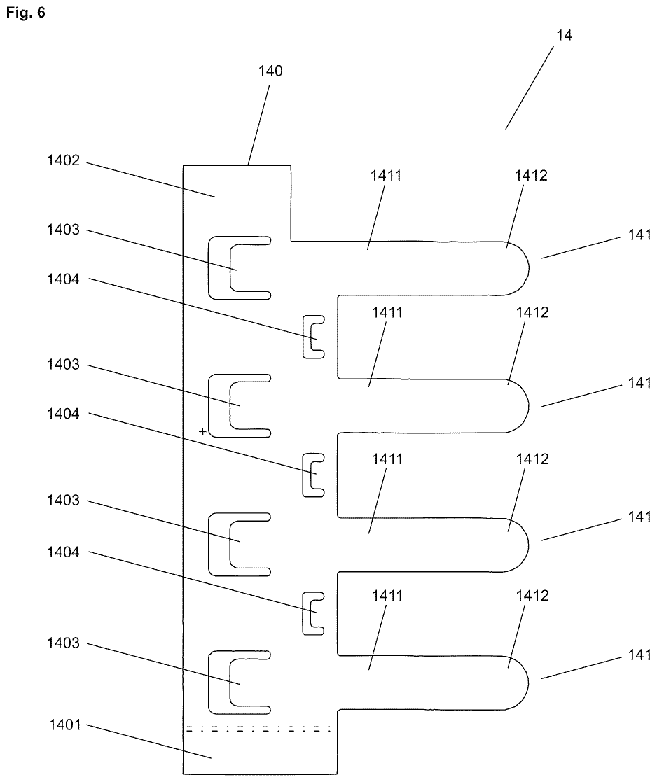

FIG. 6 a preferred embodiment of an unfolding 140 of an inventive shield contact module 14, which has a support member 140 with two end pieces 1401, 1402 that can be connected to each other;

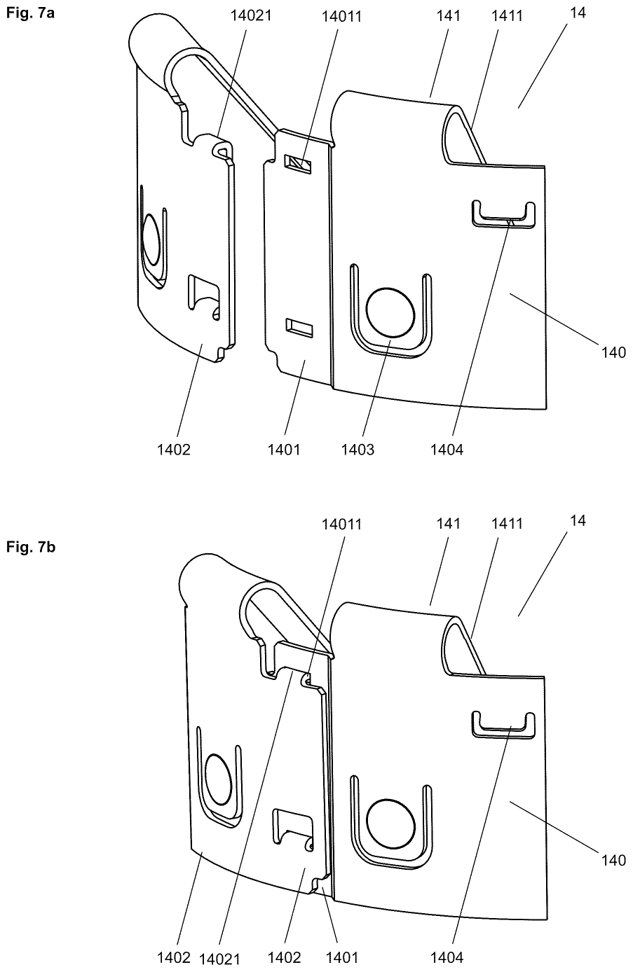

FIG. 7a a part of the shield contact module 14 manufactured from the unfolding 140 of FIG. 6 with the separate end pieces 1401, 1402; and

FIG. 7b the part of shield contact module 14 of FIG. 7a with the interconnected end pieces 1401, 1402.

FIG. 1 shows an inventive cable gland 1 connected to a mounting wall 9 in a quarter section, which reveals an inventive shield contact module 14. The cable gland 1 has a central axis x and encloses a device channel 10 into which a cable 8, shown as an example, is inserted, which has a cable sheath 81, a cable shield 82 exposed at the front, a wire insulation 83, and a single cable wire 84. The cable 8 is inserted until contact is established between the cable shield 82 and the shield contact module 14. The cable 8 is then secured as described below.

In this embodiment, the cable gland 1 comprises
a one-piece mounting socket 11, which has a socket channel 110 serving as a passage for the cable 8, a first connecting piece 111 provided with a first external thread 1111 and a second connecting piece 112 provided with a second external thread 1112, and which is connected or connectable to the mounting wall 9,
a cap nut 12, which has a cap nut channel 120 for the passage of the cable 8, a pressure cap 121, and a ring flange 122 with an internal thread 1221, which is screwed onto the second external thread 1112 of the mounting socket 11,
a securing device 13, by means of which the cable 8 can be fixed in a preferably tight manner.

To install the mounting socket 11, the first connecting piece 111 is inserted through a mounting opening 90 in the mounting wall 9 until a tool gripping ring 113 provided on the mounting socket 11 rests against the mounting wall 9 and a screw nut (not shown) can be screwed onto the connecting piece 111 to fix the mounting socket 11 to the mounting wall 9. A sealing ring 19 is provided on the underside of the tool gripping ring 113, by means of which the mounting opening 90 is sealed after installation of the mounting socket 11.

The securing device 13 known from prior art comprises, in this embodiment, a lamella basket 131 and an elastic sealing ring 132. The lamella basket 131 comprises a hollow cylindrical lamella support 1310, which carries the sealing ring 132, and a plurality of elastic lamellas 1311, which are arranged at equal intervals around the central axis x, possibly overlapping each other, and, in the absence of forces, enclose the sealing ring 132 in a vertically aligned manner.

On the inside, the cap nut 12 has a pressing surface 1211 that extends conically to the central axis x and by means of which the ends of the lamellas 1311 can be acted upon when the cap nut 12 is tightened in such a way that the lamellas 1311 are displaced and bent in a radial direction to the central axis x. During this process, the sealing ring 132 enclosed by the lamellas 1311 is pressed against the installed cable 8, so that it is mechanically fixed and tightly enclosed. The cap nut 12 has a tool gripping ring 123 for actuating it.

The shield contact module 14, which is arranged within the socket channel 110, comprises a hollow cylindrical support member 140 and a plurality of contact elements 141 connected to the support member 140, which preferably protrude into the socket channel 110 each in a plane radial to the central axis x and are provided for contacting the cable shield 82 of the cable 8.

The hollow cylindrical or sleeve-shaped support member 140, which can alternatively also be designed as a ring, is preferably seated in a press fit close to the inner wall of the first connecting part 111, whereby optimum electrical contact can be established between the contact elements 141 and the metal mounting socket 11 and thus also with the mounting wall 9. The cable shield 82 of the inserted cable 8 can therefore be electrically connected to the mounting wall 9 via the shield contact module 14, so that interference voltages on the cable shield 82 can be discharged.

According to the invention, the contact elements 141 are designed as contact tongues 141, each of which has a tongue neck 1411 that is connected to the support member 140 in one piece, optionally also form-fitting or force-fitting, and a tongue head 1412 connected to the tongue neck 1411. The design of the tongue head 1412 is described in more detail below with reference to FIG. 3a, FIG. 3b, and FIG. 3c.

FIG. 2 shows cable gland 1 of FIG. 1 with the mounting socket 11, the shield contact module 14, the lamella basket 131, the sealing ring 132, and the cap nut 12 in an exploded view.

FIG. 3a shows one of the contact tongues 141 of the shield contact module from FIG. 1. The hollow cylindrical or sleeve-shaped support member 140 is only shown in part. The tongue neck 1411 is integrally formed on the upper side of the support member 140. The support member 140 and the contact tongues 141 are preferably formed from a thin piece of metal with a material thickness d, which is, for example, in the range of 0.2 mm to 0.8 mm.

The tongue neck 1411 is elastic, while the tongue head 1412 has little or no elasticity due to its formation. The tongue neck 1411 first extends upwardly and then curves through at least approximately 180°, subsequently forming an opening angle a with the wall of the support member 140, which is preferably in the range of 30°-50°, preferably approximately 40°.

FIG. 3c shows that the tongue head 1412 forms a tongue tub with a tub space 1410 that is closed toward the central axis x. The tongue head 1412 comprises a channel-shaped tongue dish 14121 and a tongue front 14122 adjoining the tongue dish 14121, which delimits the tub space 1410 at the front. The tongue dish 14121 and the tongue front 14122 together form the surrounding tub wall 14102 and the tub bottom 14101 of the tub-shaped tongue head 1412.

FIG. 3a shows that the tongue head 1412 has a flat or slightly rounded tub back 14103, which forms a relatively large contact surface that, with the appropriate diameter of the cable 8, lies completely against the cable shield 82 and ensures good electrical contact.

The opening angle a is selected such that the edges of the tongue front 14122 cannot come into contact with the cable shield 82 of the inserted cable 8 and the tongue head 1412 is always turned against the wall of the support member 140 and not pulled against the central axis x.

FIG. 3 b shows the contact tongue of 141 FIG. 3 a from the side. It is shown that the tongue head 1412 has a first radius of curvature r1 in the area adjacent to the tongue carrier 1411 and a second radius of curvature r2 in the area of the spherical tongue front 14122. Preferably, the first radius of curvature r1 is higher than the second radius of curvature r2 by a factor in the range of 1.5-3.5, which is preferably in the range of 2.0 mm-3.0 mm. Adjacent to the tongue carrier 1411, the tongue head 1412 therefore has a relatively low slope. In contrast, the tongue front 14122 is strongly curved and serves to ensure secure mechanical contact between the cable shield 82 and the subsequent rotation of the contact tongue 141 when the cable 8 is inserted. Towards the central axis x, the tongue front 1412 forms a spherical segment which can also slide over a partially loosened braid of the cable shield 82 that no longer fits tightly against the cable insulation 83 without snagging or damaging the cable shield 82, which may be designed as a foil.

FIG. 3c further shows that the length of the tongue head 1412 is composed of the length l21 of the tongue dish 14121 and the length l22 of the tongue front 1142, wherein the length l21 of the tongue dish 14121 is approximately 2.75 times greater than the length l22 of the tongue front 1142. The tongue dish 14121 can therefore establish contact over a relatively long area.

FIG. 4a shows the upper side of the shield contact module 14 of FIG. 1 with eight contact tongues 141 directed radially against the central axis x, which have a tongue neck 1411 and a curved tongue head 1412 connected thereto.

FIG. 4b shows the underside of the shield contact module 14 of FIG. 3a. It can be seen that the tongue head 1412 of the contact tongues 141 is directed with a rounded surface toward the inserted cable 8, both from the perspective of FIG. 4a, i.e., from above, and from the perspective of FIG. 4b, i.e. from below, with a rounded surface directed towards the inserted cable 8, so that the contact tongues 141 are always displaced radially outwards against the support member 140 when the cable 8 is inserted.

FIG. 5 shows the shield contact module 14 of FIG. 3a with the unfolding 14120 of the tongue head 1412 of the contact tongues 141, which is bent into a tub shape during manufacture. A tongue head 1412 is shown as an example to illustrate that the tongue head 1412 can optionally have indentations or formations 14120 that ensure multiple contact with the cable shield 82.

FIG. 6 shows a preferred embodiment of an unfolding of an inventive shield contact module 14, which has been cut out, for example, from a preferably spring-elastic piece of sheet metal. The tongue head 1412 of the contact tongues 141 has not yet been formed and the tongue neck 1411 is not tapered in this case. The support member 140 is strip-shaped and has two end pieces 1401, 1402 which, after formation of the shield contact module 14, overlap each other in such a way that the outer diameter of the shield contact module 14 does not increase at the connection point. The first end piece 1401 is therefore offset inwards by bends along two dotted bending lines. The end pieces 1401, 1402 are connected, for example, by inserting closure tabs 14021 into closure openings 14011, as shown in FIG. 7b.

Contact springs 1403 and locking springs 1404 are also cut out of the strip that forms the support member 140. These are bent outwards during the formation of the shield contact module 14. After installation of the shield contact module 14 in the mounting socket 11, the contact springs 1403 are electrically connected to the wall of the connector channel 110. The locking springs 1404 can lock into a circumferential shoulder 1112 within the connector channel 110 (see FIG. 1), which holds the shield contact module 14 when the cable 8 is inserted into the cable gland 1 and comes into contact with the contact tongues 141.

FIG. 7a shows part of the shield contact module 14 manufactured from the unfolding 140 of FIG. 6 with the end pieces 1401, 1402 separated from each other. The first end piece 1401 is offset radially inward by bending and has two closure openings 14011. The second end piece 1402 has two closure tabs 14021 that correspond to the closure openings 14011.

FIG. 7b shows the part of the shield contact module 14 of FIG. 7a with the end pieces 1401, 1402 connected to each other. The locking tabs 14021 are hooked into the locking openings 14011 and bent over if necessary.

### LIST OF REFERENCES

1 Cable Gland
10 device channel
11 mounting socket
110 socket channel
111 first connecting piece
1111 first external thread
112 second connecting piece
1121 second external thread
113 tool gripping ring
12 cap nut
120 cap nut channel
121 pressure cap
1211 pressing surface
122 ring flange
1221 internal thread
123 tool gripping ring
13 securing device
131 lamella basket
1310 lamella support
1311 lamellas
132 sealing ring
14 shield contact module
140 support member
1401 first end piece
14011 closure opening
1402 second end piece
14021 closure flap
1403 contact spring
1404 retention spring
141 contact tongues
1410 tub space
14101 tub bottom
14102 tub wall
14103 tub back
1411 tongue neck
1412 tongue head
14120 unfolding of the tongue head
141214121 tongue dish
14122 tongue front
14125 formations, waveform
19 sealing ring
8 cable
81 cable sheath
82 cable shield
83 wire insulation
84 level
9 mounting wall
90 mounting opening a angle of inclination of the contact tongues
141l21 length of the tongue dish
14121l22 length of the tongue front
14122r1 radius of curvature in the entrance area of the tongue head
142r2 radius of curvature in the entrance area of the tongue front
14122x central axis

1. A cable gland with a central axis for feeding a cable provided with a cable shield through a mounting opening in a mounting wall, a housing wall of an electrical device or an electrical cabinet,
with a one-piece or multi-piece mounting socket which has a socket channel for the cable to pass through, a first connecting piece provided with a first external thread, and a second connecting piece provided with a second external thread, and which is connectable to the mounting wall,
with a cap nut that has a cap nut channel for the cable to pass through, a pressure cap, and a ring flange with an internal thread that corresponds to the second external thread of the mounting socket,
with a securing device by means of which the cable can be fixed in a tight-fitting manner, and
with a shield contact module, which is arranged within the socket channel, which has an annular or hollow cylindrical support member and several contact elements connected to the support member, which protrude into the socket channel and are provided for contacting the cable shield of the cable,
wherein the contact elements are formed as contact tongues, each of which has a tongue neck connected to the support member and a tongue head adjoining the tongue neck, which tongue head forms a tongue tub with a tub space that is closed toward the central axis and is bounded by a tub bottom facing the central axis and a continuous closed tub wall, which is adjoining the tub bottom.

2. The cable gland according to claim 1, wherein the tongue neck is formed in the manner of a gooseneck and extends along a curve of approximately 180° to the tongue head.

3. The cable gland according to claim 1, wherein the tongue head comprises a channel-shaped tongue dish and a tongue front adjoining the tongue dish, which closes off the tub space at the front and is rounded or designed as a spherical segment.

4. The cable gland according to-claim 1, wherein the tub-shaped tongue head has a flat or curved tub back that forms a contact surface.

5. The cable gland according to-claim 1, wherein the tub bottom has indentations or formations which are wave-shaped and/or are provided within a concave area in the tub bottom.

6. The cable gland according to-claim 1, wherein the length of the tongue head is composed of the length of the tongue dish and the length of the tongue front, wherein the length of the tongue dish is approximately a factor in the range of 1.5-5.0 greater than the length of the tongue front.

7. The cable gland according to-claim 1, wherein the support member is hollow cylindrical and has a support wall that is in electrical contact with the channel wall of the connector channel, and wherein the contact tongues form an opening angle with the support wall, which is in the range of 30°-50°.

8. The cable gland according to-claim 1, wherein a first radius of curvature in the area of the tongue head adjacent to the tongue carrier is higher by a factor in the range of 1.5-3.5 than a second radius of curvature in the area of the tongue front.

9. The cable gland according to-claim 1,
wherein the support member and the contact tongues integrally connected to the support member are cut out and formed from a sheet metal part; or
wherein the support member and the contact tongues are connected to each other in a form-fitting, force-fitting manner by means of a welded connection or an adhesive connection.

10. The cable gland according to-claim 1, wherein the support member is sleeve-shaped and held in the socket channel in a press fit or form-fitting manner.

11. The cable gland according to-claim 1,
a) wherein the support member has overlapping end pieces that are connected to each other by locking elements that engage each other in a form-fitting manner; and/or
b) wherein contact springs are bent out of the support member and are bent radially outward relative to the central axis, which contact springs electrically contact the wall of the connector channel; and/or
c) wherein latching springs are bent out of the support member and are bent radially outward relative to the central axis, which are latched onto a circumferential shoulder on the wall of the connector channel.

12. The cable gland according to-claim 1, wherein the contact tongues are inclined in a direction away from the cap nut.

13. The cable gland according to-claim 1, wherein the support member is provided on both sides with contact tongues that are directed toward each other and inclined toward the central axis.

14. The cable gland according to-claim 1, wherein the securing device comprises a lamella basket with lamellas directed towards the cap nut, and a sealing ring enclosed by the lamellas.

15. A shield contact module for a cable gland according to claim 1, with a central axis for feeding through a cable provided with a cable shield, with an annular or hollow cylindrical support member and a plurality of contact elements connected to the support member, which face the central axis and are provided for contacting the cable shield of the cable, wherein the contact elements are formed as contact tongues, each of which has a tongue neck connected to the support member and a tongue head adjoining the tongue neck, which tongue head forms a tongue tub with a tub space that is closed toward the central axis and is bounded by a tub bottom facing the central axis and a continuous closed tub wall, which is adjoining the tub bottom.
